(19) United States
(12) Patent Application Publication
(10) Pub. No.: US 2026/0286048 A1
(43) Pub. Date: Sep. 24, 2026

(54) POLYCARBONATE RESIN AND OPTICAL MEMBER USING SAID RESIN

(71) Applicant: TEIJIN LIMITED, Osaka (JP)

(72) Inventors: Eiji UTO, Osaka (JP); Kazunori NUNOME, Osaka (JP)

(73) Assignee: TEIJIN LIMITED, Osaka (JP)

(21) Appl. No.: 19/476,402

(22) PCT Filed: Apr. 15, 2024
(86) PCT No.: PCT/JP2024/014996

§ 371 Date: Oct. 17, 2025

(30) Foreign Application Priority Data
Apr. 25, 2023 (JP) 2023-071249
Apr. 25, 2023 (JP) 2023-071250

(51) Int. Cl. C08G 64/16; C08G 64/30; G02B 1/04

(52) U.S. Cl. CPC C08G 64/1608; C08G 64/305; G02B 1/041

(57) ABSTRACT

A first object according to the invention is to provide a polycarbonate resin having excellent fluidity and small orientation birefringence.

A second object of the invention is to provide, in addition to the first object, a polycarbonate resin having a high Abbe number and small orientation birefringence and photoelastic coefficient.

A third object of the invention is to provide, in addition to the first object, a polycarbonate resin having a small orientation birefringence and a high refractive index and a high glass transition temperature.

A polycarbonate resin includes: a unit represented by Formula (1) and/or Formula (2); and a unit represented by Formula (3), in which the polycarbonate resin has a weight average molecular weight Mw of 10,000 to 55,000,

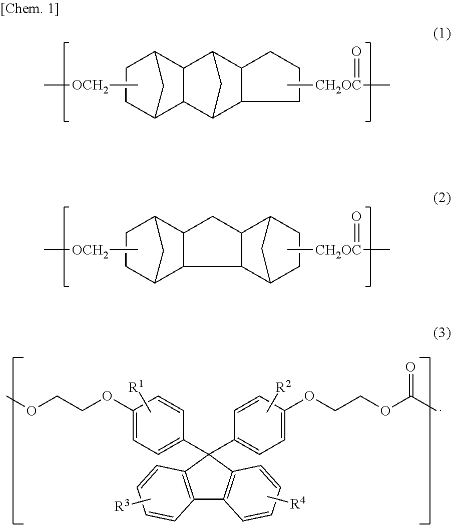

(where R¹ to R⁴ each independently represent a hydrogen atom or a hydrocarbon group having 1 to 10 carbon atoms).

### TECHNICAL FIELD

The present invention relates to a polycarbonate resin and an optical member using the resin.

### BACKGROUND ART

In the related art, glass to be used as a material for an optical system can achieve various required optical properties and is excellent in environmental resistance, but has a problem of poor processability. In response to this, a resin, which is cheaper than the glass materials and has excellent processability, has been used for an optical member.

PTL 1 discloses an optical lens having a high refractive index and low orientation birefringence, which is made of a polycarbonate resin having a structure of pentacyclopentadecanedimethanol (hereinafter, sometimes abbreviated as PCPDM) and 9,9-bis[4-(2-hydroxyethoxy)phenyl]fluorene (hereinafter, sometimes abbreviated as BPEF).

In an optical design of an optical unit, it is known that chromatic aberration is corrected by using a plurality of lenses having different Abbe numbers in combination. For example, a lens made of an alicyclic polyolefin resin having a low refractive index and a high Abbe number and a lens made of a polycarbonate resin including bisphenol A having a high refractive index and a low Abbe number (nd=1.59, vd=31) are combined to correct the chromatic aberration. In recent years, a resin having a high refractive index and a low Abbe number is actively developed, and accordingly, a resin having a high Abbe number is also demanded. In addition, polycarbonate resins from bisphenol A, which are obtained by reacting 2, 2-bis(4-hydroxyphenyl) propane (commonly known as bisphenol A) with phosgene or carbonate esters, are excellent in heat resistance and transparency, and also in mechanical properties such as impact resistance, and thus are widely used not only as structural materials but also as optical materials for optical disk substrates, various lenses, prisms, optical fibers, and the like. However, the polycarbonate resin from bisphenol A has a problem that birefringence due to molecular orientation and residual stress during molding is large. Therefore, with the spread of optical material applications in recent years, there is a strong demand for development of materials having lower birefringence. For example, PTL 2 discloses a polycarbonate resin having a low photoelastic coefficient while having a high Abbe number by copolymerizing bisphenol A and PCPDM. PTL 3 proposes a method for producing a carbonate derivative without using a base by subjecting halogenated methane and a specific amount of a hydroxyl group-containing compound to a photoreaction in the presence of oxygen, and cites as an example of the production a copolymerized polycarbonate of BPEF and PCPDM.

### CITATION LIST

### Patent Literature

PTL 1: JP2005-241962A
PTL 2: JP2000-302860A
PTL 3: WO2020/100977

### SUMMARY OF INVENTION

### Technical Problem

However, when the polycarbonate resin having the structures of the PCPDM and the BPEF described above is applied to a thin optical member such as an imaging lens, it is difficult to form the polycarbonate resin, and the orientation birefringence also needs to be further improved. In addition, the above-described polycarbonate resin formed of bisphenol A and PCPDM has problems that there is room for improvement in photoelastic coefficient, and has problems such as large orientation birefringence, low refractive index and low glass transition temperature. Further, since a molecular weight of the obtained resin is high, the resin is not suitable for injection molding, and cannot be used for a thin optical member such as an imaging lens. In addition, the above-described copolymer polycarbonate of BPEF and PCPDM has an extremely low weight average molecular weight of 3,360, and is not a sufficient polymer for use as a structural material or an optical material.

Therefore, a first object of the invention is to provide a polycarbonate resin having excellent fluidity and small orientation birefringence.

A second object of the invention is to provide, in addition to the first object, a polycarbonate resin having a high Abbe number and small orientation birefringence and photoelastic coefficient.

A third object of the invention is to provide, in addition to the first object, a polycarbonate resin having a small orientation birefringence and a high refractive index and a high glass transition temperature.

### Solution to Problem

The present inventors have found that the above problems can be solved by the invention having the following aspects.

That is, the invention is as follows.

### <<Aspect 1>>

A polycarbonate resin comprises: a unit represented by Formula (1) and/or Formula (2); and a unit represented by Formula (3), wherein the polycarbonate resin has a weight average molecular weight Mw of 10,000 to 55,000,

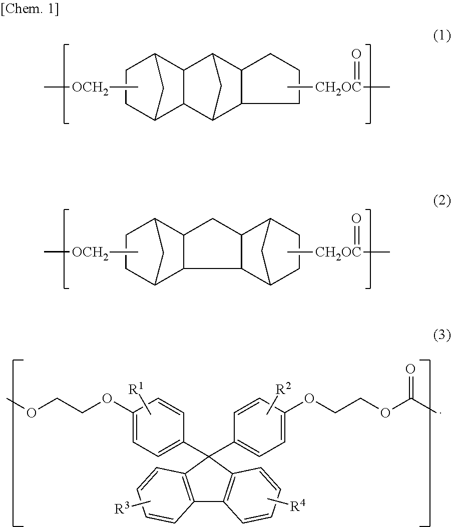

where R¹~R⁴ each independently represent a hydrogen atom or a hydrocarbon group having 1 to 10 carbon atoms.

### <<Aspect 2>>

In the polycarbonate resin according to Aspect 1, R¹ to R⁴ in the Formula (3) is a hydrogen atom.

### <<Aspect 3>>

In the polycarbonate resin according to Aspect 1 or 2, a molar ratio of the unit represented by Formula (1) and/or Formula (2) to the unit represented by Formula (3) is 99:1 to 1:99.

### <<Aspect 4>>

In the polycarbonate resin according to Aspect 3, the molar ratio of the unit represented by Formula (1) and/or Formula (2) to the unit represented by Formula (3) is 65:35 to 35:65.

### <<Aspect 5>>

In the polycarbonate resin according to Aspect 1 or 2, an absolute value of orientation birefringence is 7.0×10⁻³ or less.

### <<Aspect 6>>

In the polycarbonate resin according to Aspect 1 or 2, the polycarbonate resin has a photoelastic coefficient of less than 35×10⁻¹² Pa.

### <<Aspect 7>>

In the polycarbonate resin according to Aspect 1, the unit represented by Formula (1) and/or Formula (2) is contained in an amount of 50 mol % or more in all repeating units, and the weight average molecular weight Mw is 10,000 to 50,000.

### <<Aspect 8>>

In the polycarbonate resin according to Aspect 7, the unit represented by Formula (3) is contained in an amount of more than 0 mol % and 50 mol % or less in all repeating units.

### <<Aspect 9>>

In the polycarbonate resin according to Aspect 7 or 8, a molar ratio of the unit represented by Formula (1) and/or Formula (2) to the unit represented by Formula (3) is 99:1 to 50:50.

### <<Aspect 10>>

In the polycarbonate resin according to Aspect 7 or 8, the polycarbonate resin has a photoelastic coefficient of less than 25×10⁻¹² Pa.

### <<Aspect 11>>

In the polycarbonate resin according to Aspect 7 or 8, the polycarbonate resin has an Abbe number of 25.0 or more.

### <<Aspect 12>>

In the polycarbonate resin according to Aspect 1, the unit represented by Formula (1) and/or Formula (2) is contained in an amount of more than 0 mol % and less than 50 mol % in all repeating units, and the weight average molecular weight Mw is 10,000 to 50,000.

### <<Aspect 13>>

In the polycarbonate resin according to Aspect 12, the unit represented by Formula (3) is contained in an amount of more than 50 mol % in all repeating units.

### <<Aspect 14>>

In the polycarbonate resin according to Aspect 12 or 13, a molar ratio of the unit represented by Formula (1) and/or Formula (2) to the unit represented by Formula (3) is 1:99 to 49:51.

### <<Aspect 15>>

In the polycarbonate resin according to Aspect 12 or 13, an absolute value of orientation birefringence is 3.0×10⁻³ or less.

### <<Aspect 16>>

In the polycarbonate resin according to Aspect 12 or 13, the polycarbonate resin has a refractive index nd of 1.600 or more.

### <<Aspect 17>>

In the polycarbonate resin according to Aspect 12 or 13, the polycarbonate resin has a glass transition temperature of 140° C. or higher.

### <<Aspect 18>>

An optical member comprises: the polycarbonate resin according to any one of Aspects 1, 2, 7, or 12.

### <<Aspect 19>>

In the optical member according to Aspect 18, the optical member is an imaging lens or a sensing camera lens.

### <<Aspect 20>>

In the imaging lens or the sensing camera lens according to Aspect 19, a thickness of a central portion is 0.05 mm to 3.0 mm.

### Advantageous Effects of Invention

A polycarbonate resin according to the invention has excellent fluidity and small orientation birefringence. Therefore, the polycarbonate resin can be suitably used for a thin optical member such as an imaging lens, and an industrial effect thereof is remarkable.

The polycarbonate resin according to the invention has a high Abbe number and a small orientation birefringence and a small photoelastic coefficient.

Another more preferable polycarbonate resin according to the invention has a small orientation birefringence and a high refractive index and a high transition temperature. In this way, the industrial effect of the polycarbonate resin according to the invention is remarkable.

### DESCRIPTION OF EMBODIMENTS

The invention will be described in more detail.

### Embodiment 1

### <Polycarbonate Resin>

Provided is a polycarbonate resin containing a unit represented by Formula (1) and/or Formula (2) and a unit represented by Formula (3), and having a weight average molecular weight Mw of 10,000 or more and 55,000 or less.

The polycarbonate resin according to the invention contains a unit represented by Formula (1) and/or Formula (2) and a unit represented by Formula (3). The unit represented by Formula (1) and/or Formula (2) is contained in an amount of more than 0 mol % and less than 100 mol % in all repeating units, and the unit represented by Formula (3) is contained in an amount of more than 0 mol % and less than 100 mol % in all repeating units. The unit represented by Formula (1) and/or Formula (2) is preferably 10 mol % or more, more preferably 20 mol % or more, and still more preferably 35 mol % or more in all repeating units. In addition, the unit represented by Formula (1) and/or Formula (2) is preferably 90 mol % or less, more preferably 80 mol % or less, and still more preferably 65 mol % or less in all repeating units. Within the above range, the orientation birefringence is small, and a balance among a refractive index, an Abbe number, and a photoelastic coefficient is excellent. A molar ratio of the unit represented by Formula (1) and/or Formula (2) to the unit represented by Formula (3) is preferably 99:1 to 1:99, more preferably 80:20 to 20:80, and still more preferably 65:35 to 35:65. When the unit represented by Formula (1) and/or Formula (2) and the unit represented by Formula (3) are within the above ranges, the orientation birefringence is small, and the balance among the refractive index, the Abbe number, and the photoelastic coefficient is excellent.

In the definition of mol % and the molar ratio described above, the unit represented by Formula (1) and/or Formula (2) represents a total unit of Formula (1) and Formula (2) when the unit represented by Formula (1) and Formula (2) is included in the polycarbonate resin, and represents any one unit included when any one of the units represented by Formula (1) and Formula (2) is included.

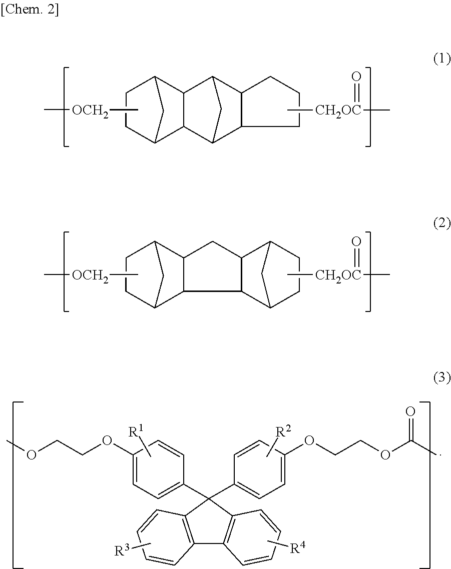

(In the formula, R¹ to R⁴ each independently represent a hydrogen atom or a hydrocarbon group having 1 to 10 carbon atoms.)

The polycarbonate resin according to the invention has a weight average molecular weight Mw of 10,000 or more, preferably 15,000 or more, and more preferably 20,000 or more. When the weight average molecular weight Mw is 10,000 or more, sufficient mechanical strength is obtained as a structural material or an optical material, which is preferable. The weight average molecular weight Mw is 55,000 or less, preferably 50,000 or less, more preferably 40,000 or less, particularly preferably less than 35,000, and most preferably 30,000 or less. When the weight average molecular weight Mw is 55,000 or less, fluidity during injection molding is excellent, which is preferable. In particular, when the polycarbonate resin according to the invention is used for a thin optical member such as an imaging lens, the polycarbonate resin has excellent fluidity, which is preferable. The weight average molecular weight Mw can be measured by GPC using polystyrene having a known molecular weight as a standard sample and chloroform as a developing solvent.

The polycarbonate resin according to the invention preferably has an absolute value of orientation birefringence of 7.0×10⁻³ or less. When the absolute value of the orientation birefringence is equal to or less than the above, birefringence due to molecular orientation is less likely to occur, which is preferable. The orientation birefringence is measured at a wavelength of 589 nm after a test piece having a length of 70 mm (between chucks of 45 mm) and a width of 15 mm is cut out from a cast film having a thickness of 100 μm obtained from a polycarbonate resin and stretched twice at Tg+10° C.

The polycarbonate resin according to the invention preferably has a photoelastic coefficient of less than 35×10⁻¹² Pa. When the photoelastic coefficient is within the above range, birefringence due to stress is less likely to occur, which is preferable. The photoelastic coefficient is measured by cutting a test piece having a length of 50 mm and a width of 10 mm from a cast film having a thickness of 100 μm obtained 1 from a polycarbonate resin, using Spectroellipsometer M-220 manufactured by JASCO Corporation.

The polycarbonate resin according to the invention preferably has a refractive index nd of 1.540 or more as measured at a temperature of 20° C. and a wavelength of 587.56 nm. When the refractive index is the above range or more, the optical member can be thinned, which is preferable. The refractive index nd may be 1.650 or less. When the refractive index nd is within the above range, a degree of freedom in optical design is increased when a plurality of lenses are used in combination, which is preferable.

The polycarbonate resin according to the invention preferably has an Abbe number of 25.0 or more. When the Abbe number is equal to or greater than the above range, the chromatic aberration of the optical member is reduced, which is preferable. The Abbe number may be 57.0 or less. When the Abbe number is within the above range, the degree of freedom in optical design is increased when a plurality of lenses are used in combination, which is preferable.

Here, the Abbe number (vd) is calculated using the following formula based on the refractive index at a temperature of 20° C. and wavelengths of 486.13 nm, 587.56 nm, and 656.27 nm.

$$ν d = ( nd - 1 ) / ( nF - nC )$$

nd means a refractive index at a wavelength of 587.56 nm, nF means a refractive index at a wavelength of 486.13 nm, and nC means a refractive index at a wavelength of 656.27 nm.

The polycarbonate resin according to the invention preferably has a glass transition temperature of 130° C. or higher. When the glass transition temperature is in the above range, a temperature range in which the optical member can be used is increased, which is preferable. The glass transition temperature may be 160° C. or lower. When the glass transition temperature is within the above range, a balance between heat resistance and moldability is excellent, which is preferable.

The polycarbonate resin according to the invention preferably has a thermal decomposition temperature of 370° C. or higher. When the thermal decomposition temperature is equal to or higher than the above range, the polycarbonate resin according to the invention is excellent in processing stability at the time of molding, and is also less colored, which is preferable. The thermal decomposition temperature may be 420° C. or lower. The thermal decomposition temperature can be measured by thermogravimetric analysis (TGA), and is a temperature at which the weight is reduced by 5%.

The polycarbonate resin according to the invention preferably has a melt viscosity (Pas) of 30 or more at 260° C. and a shear rate of 1,216/sec. It is also preferable that the melt viscosity (Pas) at 260° C. and a shear rate of 1,216/see is 500 or less. When the melt viscosity is within the above range, moldability during injection molding is excellent, which is preferable. In particular, when a thin molded product such as a lens is injection-molded, the melt viscosity during molding is important, and when the melt viscosity is within the above range, a target lens shape is obtained, which is preferable. The melt viscosity is measured by Capirograph 1D manufactured by Toyo Seiki Co., Ltd. after drying the polycarbonate resin at 120° C. for 4 hours.

The specific viscosity of the polycarbonate resin according to the invention is preferably 0.12 to 0.32. When the specific viscosity is 0.12 to 0.32, a balance between moldability and strength is excellent.

As a method for measuring the specific viscosity, a specific viscosity (nSP) at 20° C. of a solution obtained by dissolving 0.7 g of a polycarbonate resin in 100 ml of methylene chloride is measured with an Ostwald viscometer, and the specific viscosity is calculated based on the following formula.

$$η SP = ( t - t 0 ) / t 0$$

[to is the number of seconds that methylene chloride falls, and t is the number of seconds that a sample solution falls]

In the polycarbonate resin according to the invention, each of R¹ to R⁴ in Formula (3) independently represents a hydrogen atom or a hydrocarbon group having 1 to 10 carbon atoms, and examples of the hydrocarbon group include an alkyl group, a cycloalkyl group, and an aryl group.

Examples of the alkyl group include a methyl group, an ethyl group, a propyl group, an isopropyl group, a butyl group, and a t-butyl group, and a methyl group and an ethyl group are preferable.

Examples of the cycloalkyl group include a cyclopropyl group, a cyclobutyl group, a cyclopentyl group, a cyclohexyl group, and a bicyclo[1.1.1]pentanyl group.

Examples of the aryl group include a phenyl group, a tolyl group, a naphthyl group, and a xylyl group, and a phenyl group is preferable.

Each of R¹ to R⁴ is independently preferably a hydrogen atom, a methyl group, or a phenyl group, more preferably a hydrogen atom or a phenyl group, each of R¹ and R² is independently preferably a hydrogen atom or a phenyl group, and each of R³ and R⁴ is still more preferably a hydrogen atom.

The repeating unit represented by the above Formula (1) and/or the above Formula (2) is a repeating unit derived from pentacyclopentadecanedimethanol, and in the above Formula (1) and/or the above Formula (2), it may be a pure substance or a mixture in which respective isomers are mixed at any ratio. Pentacyclopentadecanedimethanol includes the following structural formula.

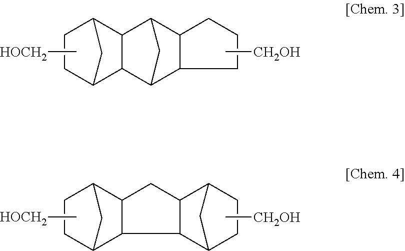

The repeating unit represented by the above Formula (3) is preferably a repeating unit derived from 9,9-bis[4-(2-hydroxyethoxy)phenyl]fluorene or 9, 9-bis[4-(2-hydroxyethoxy)-3-phenylphenyl]fluorene, and more preferably a repeating unit derived from 9, 9-bis[4-(2-hydroxyethoxy)phenyl]fluorene.

The polycarbonate resin according to the invention may contain a repeating unit other than the repeating unit represented by the above Formulas (1) to (3) as long as an advantageous effect of the invention is obtained. Examples of the dihydroxy compounds that result in such repeating units include ethylene glycol, propanediol, butanediol, pentanediol, hexanediol, heptanediol, octanediol, nonanediol, tricyclo[5. 2. 1. 02, 6]decanedimethanol, cyclohexane-1,4-dimethanol, decalin-2, 6-dimethanol, norbornanedimethanol, cyclopentane-1,3-dimethanol, isosorbide, isomannide, isoidide, hydroquinone, resorcinol, 2, 2-bis(4-hydroxyphenyl) propane, 2,2-bis(3-methyl-4-hydroxyphenyl) propane, 1,1-bis(4-hydroxyphenyl)-1-phenylethane, bis(4-hydroxyphenyl)diphenylmethane, 1,3-bis(2-(4-hydroxyphenyl)-2-propyl)benzene, 4,4′-(3, 3, 5-trimethylcyclohexylidene)bisphenol, 4,4′-cyclohexylidenebisphenol, 4,4′-(3-methylcyclohexylidene)bisphenol, bis(4-hydroxyphenyl) sulfone, bis(4-hydroxyphenyl) sulfide, biphenol, bisphenolfluorene, biscresolfluorene, 1, 1′-bi-2-naphthol, and 2, 2′-bis(2-hydroxyethoxy)-1, 1-binaphthalene. Such a repeating unit may be 30 mol % or less in all repeating units.

In the polycarbonate resin according to the invention, the total of the repeating units represented by the Formulas (1) to (3) is preferably 70 mol % or more, more preferably 80 mol % or more, and still more preferably 90 mol % or more in all the repeating units.

Terminals of the polycarbonate resin according to the invention are formed of a hydroxyl group or a phenyl group, and a ratio of a terminal phenyl group is preferably 70 mol % or more, more preferably 80 mol % or more, still more preferably 90 mol % or more, and yet still more preferably 95 mol % or more in all terminals.

In the polycarbonate resin according to the invention, a total light transmittance of a molded body having a thickness of 1 mm is preferably 80% or more, more preferably 85% or more, and particularly preferably 88% or more. The molded body having a thickness of 1 mm is obtained by injection molding, hot press molding, melt extrusion molding, or the like of the polycarbonate resin according to the invention.

A saturated water absorption of the polycarbonate resin according to the invention may be 0.10% to 0.70%, 0.20% to 0.70%, or 0.30% to 0.65%.

### <Method for Producing Polycarbonate Resin>

The polycarbonate resin according to the invention is produced by a known reaction method for producing any polycarbonate resin, for example, a method for reacting a dihydroxy compound with a carbonate precursor such as a carbonic acid diester. Next, basic methods for these production methods will be briefly described.

A transesterification reaction using a carbonic acid diester as a carbonate precursor is performed by stirring a predetermined ratio of dihydroxy component with a carbonic acid diester under heating in an inert gas atmosphere, and distilling off the resulting alcohol or phenol. A reaction temperature varies depending on a boiling point of the alcohol or phenol to be generated, and is usually in the range of 120° C. to 300° C. The reaction is completed while distilling off the generated alcohol or phenols from an initial stage under reduced pressure. If necessary, a terminal stopper, an antioxidant, or the like may be added.

Examples of the carbonic acid diester to be used in the transesterification reaction include an ester such as an aryl group or an aralkyl group having 6 to 12 carbon atoms which may be substituted. Specific examples include diphenyl carbonate, ditolyl carbonate, bis(chlorophenyl) carbonate, and m-cresyl carbonate. Among these, diphenyl carbonate is particularly preferable. An amount of diphenyl carbonate to be used is preferably 0.95 mol to 1.10 mol, more preferably 0.98 mol to 1.04 mol, per mol of the total amount of the dihydroxy compounds.

In a melt polymerization method, a polymerization catalyst can be used to increase a polymerization rate, and examples of the polymerization catalyst include an alkali metal compound, an alkaline earth metal compound, and a nitrogen-containing compound.

As such a compound, an organic acid salt, an inorganic salt, an oxide, a hydroxide, a hydride, an alkoxide, a quaternary ammonium hydroxide, or the like of an alkali metal or an alkaline earth metal is preferably used, and these compounds can be used alone or in combination.

Examples of the alkali metal compound include sodium hydroxide, potassium hydroxide, cesium hydroxide, lithium hydroxide, sodium bicarbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, sodium borohydride, sodium benzoate, potassium benzoate, cesium benzoate, lithium benzoate, disodium hydrogen phosphate, dipotassium hydrogen phosphate, dilithium hydrogen phosphate, disodium phenylphosphate, disodium salt, dipotassium salt, dicesium salt, and dilithium salt of bisphenol A, and sodium salt, potassium salt, cesium salt, and lithium salt of phenol.

Examples of the alkaline earth metal compound include magnesium hydroxide, calcium hydroxide, strontium hydroxide, barium hydroxide, magnesium carbonate, calcium carbonate, strontium carbonate, barium carbonate, magnesium diacetate, calcium diacetate, strontium diacetate, and barium diacetate.

Examples of the nitrogen-containing compound include quaternary ammonium hydroxides having an alkyl or aryl group, such as tetramethylammonium hydroxide, tetraethylammonium hydroxide, tetrapropylammonium hydroxide, tetrabutylammonium hydroxide, and trimethylbenzylammonium hydroxide. Examples thereof include bases or basic salts such as tetramethylammonium borohydride, tetrabutylammonium borohydride, tetrabutylammonium tetraphenylborate, and tetraphenylammonium tetraphenylborate.

Examples of other transesterification catalysts include salts of zinc, tin, zirconium, lead, titanium, germanium, antimony, and osmium, and examples thereof include zinc acetate, zinc benzoate, zinc 2-ethylhexanoate, tin (II) chloride, tin (IV) chloride, tin (II) acetate, tin (IV) acetate, dibutyltin dilaurate, dibutyltin oxide, dibutyltin dimethoxide, zirconium acetylacetonate, zirconium oxyacetate, zirconium tetrabutoxide, lead (II) acetate, lead (IV) acetate, and titanium tetrabutoxide (IV). Catalysts to be used in International Publication No. WO2011/010741 and JP2017-179323A may be used.

Further, a catalyst formed of aluminum or a compound thereof and a phosphorus compound may be used. In this case, the amount is preferably 80 μmol to 1000 μmol, more preferably 90 μmol to 800 μmol, and still more preferably 100 μmol to 600 μmol per mol of the dihydroxy component.

Examples of the aluminum salt include organic acid salts and inorganic acid salts of aluminum. Examples of the organic acid salt of aluminum include carboxylate of aluminum, and specific examples thereof include aluminum formate, aluminum acetate, aluminum propionate, aluminum oxalate, aluminum acrylate, aluminum laurate, aluminum stearate, aluminum benzoate, aluminum trichloroacetate, aluminum lactate, aluminum citrate, and aluminum salicylate. Examples of the inorganic acid salt of aluminum include aluminum chloride, aluminum hydroxide, aluminum chloride hydroxide, aluminum carbonate, aluminum phosphate, and aluminum phosphonate. Examples of the aluminum chelate compound include aluminum acetylacetonate, aluminum acetyl acetate, aluminum ethyl acetoacetate, and aluminum ethyl acetoacetate diisopropoxide.

Examples of the phosphorus compound include a phosphonic acid-based compound, a phosphinic acid-based compound, a phosphine oxide-based compound, a phosphonous acid-based compound, a phosphinous acid-based compound, and a phosphine-based compound. Among these, a phosphonic acid-based compound, a phosphinic acid-based compound, and a phosphine oxide-based compound can be particularly exemplified, and a phosphonic acid-based compound can be particularly exemplified.

An amount of these polymerization catalysts to be used is preferably 0.1 μmol to 500 μmol, more preferably 0.5 μmol to 300 μmol, and still more preferably 1 μmol to 100 μmol, per mol of the dihydroxy component.

In addition, a catalyst deactivator may be added in a later stage of the reaction. As the catalyst deactivator to be used, known catalyst deactivators are effectively used, and among them, ammonium salts and phosphonium salts of sulfonic acids are preferable. Further, dodecylbenzenesulfonic acid salts such as tetrabutylphosphonium dodecylbenzenesulfonate and p-toluenesulfonic acid salts such as tetrabutylammonium p-toluenesulfonate are preferable.

As the esters of sulfonic acid, methyl benzenesulfonate, ethyl benzenesulfonate, butyl benzenesulfonate, octyl benzenesulfonate, phenyl benzenesulfonate, methyl paratoluenesulfonate, ethyl paratoluenesulfonate, butyl paratoluenesulfonate, octyl paratoluenesulfonate, phenyl paratoluenesulfonate, and the like are preferably used. Among these, tetrabutylphosphonium dodecylbenzenesulfonate is most preferably used.

When at least one polymerization catalyst selected from alkali metal compounds and/or alkaline earth metal compounds is used, the catalyst deactivator may be used in an amount of preferably 0.5 mol to 50 mol, more preferably 0.5 mol to 10 mol, and still more preferably 0.8 mol to 5 mol, per mol of the catalyst.

### <Optional Additive>

The polycarbonate resin according to the invention can be used as a resin composition by appropriately adding additives such as a release agent, a heat stabilizer (also referred to as an antioxidant in some cases), an ultraviolet absorber, a bluing agent, an antistatic agent, a flame retardant, a plasticizer, a filler, an antioxidant, a light stabilizer, a polymerized metal deactivator, a lubricant, a surfactant, and an antibacterial agent, as necessary. Specific examples of the release agent and the heat stabilizer include those described in WO2011/010741.

Particularly preferable examples of the release agents include stearic acid monoglyceride, stearic acid triglyceride, pentaerythritol tetrastearate, and a mixture of stearic acid triglyceride and stearyl stearate. An amount of the ester in the release agent is preferably 90% by weight or more, and more preferably 95% by weight or more, when the release agent is taken as 100% by weight. A content of the release agent is preferably in the range of 0.005 to 2.0 parts by weight, more preferably in the range of 0.01 to 0.6 parts by weight, and still more preferably in the range of 0.02 to 0.5 parts by weight with respect to 100 parts by weight of the polycarbonate resin.

Examples of the heat stabilizer include a phosphorus-based heat stabilizer, a sulfur-based heat stabilizer, and a hindered phenol-based heat stabilizer.

Particularly preferable examples of the phosphorus-based heat stabilizer include tris(2,4-di-tert-butylphenyl) phosphite, bis(2,6-di-tert-butyl-4-methylphenyl) pentaerythritol diphosphite, tetrakis(2,4-di-tert-butylphenyl)-4, 4′-biphenylene diphosphonite, distearylpentaerythritol diphosphite, bis(2, 4-dicumylphenyl) pentaerythritol diphosphite, cyclic neopentanetetraylbis(2,6-di-tert-butyl-4-methylphenyl phosphite), and bis(2,4-di-tert-butylphenyl) pentaerythritol diphosphite. A content of the phosphorus-based heat stabilizer is preferably 0.001 to 0.2 parts by weight with respect to 100 parts by weight of the polycarbonate resin.

A particularly preferable example of the sulfur-based heat stabilizer is pentaerythritol-tetrakis(3-laurylthiopropionate). A content of the sulfur-based heat stabilizer is preferably 0.001 to 0.2 parts by weight with respect to 100 parts by weight of the polycarbonate resin.

Preferred examples of the hindered phenol-based heat stabilizer include octadecyl-3-(3,5-di-tert-butyl-4-hydroxyphenyl) propionate, pentaerythritol-tetrakis[3-(3, 5-di-tert-butyl-4-hydroxyphenyl) propionate], triethylene glycol-bis[3-(3-tert-butyl-5-methyl-4-hydroxyphenyl) propionate], 1,6-hexanediol-bis[3-(3,5-di-tert-butyl-4-hydroxyphenyl) propionate], 1, 3, 5-trimethyl-2, 4, 6-tris(3, 5-di-tert-butyl-4-hydroxybenzyl)benzene, N, N-hexamethylenebis(3,5-di-tert-butyl-4-hydroxyhydrocinnamide), 3, 5-di-tert-butyl-4-hydroxybenzylphosphonate-diethyl ester, tris(3,5-di-tert-butyl-4-hydroxybenzyl) isocyanurate, 3, 9-bis {1, 1-dimethyl-2-[β-(3-tert-butyl-4-hydroxy-5-methylphenyl) propionyloxy]ethyl}-2, 4, 8, 10-tetraoxaspiro(5, 5) undecane.

A content of the hindered phenol-based heat stabilizer is preferably 0.001 to 0.3 parts by weight with respect to 100 parts by weight of the polycarbonate resin.

The phosphorus-based heat stabilizer and the hindered phenol-based heat stabilizer may be used in combination.

An ultraviolet absorber is preferably at least one ultraviolet absorber selected from the group consisting of benzotriazole-based ultraviolet absorbers, benzophenone-based ultraviolet absorbers, triazine-based ultraviolet absorbers, cyclic iminoester-based ultraviolet absorbers, and cyanoacrylate-based ultraviolet absorbers.

The benzotriazole-based ultraviolet absorbers are more preferably 2-(2-hydroxy-5-tert-octylphenyl)benzotriazole and 2, 2′-methylenebis[4-(1, 1, 3, 3-tetramethylbutyl)-6-(2H-benzotriazol-2-yl) phenol].

Examples of the benzophenone-based ultraviolet absorbers include 2-hydroxy-4-n-dodecyloxybenzophenone and 2-hydroxy-4-methoxy-2′-carboxybenzophenone.

Examples of triazine-based ultraviolet absorbers include 2-(4, 6-diphenyl-1, 3, 5-triazin-2-yl)-5-[(hexyl)oxy]-phenol and 2-(4, 6-bis(2, 4-dimethylphenyl)-1, 3, 5-triazin-2-yl)-5-[(octyl)oxy]-phenol.

As the cyclic iminoester-based ultraviolet absorber, 2, 2′-p-phenylenebis(3, 1-benzoxazin-4-one) is particularly suitable.

Examples of the cyanoacrylate-based ultraviolet absorbers include 1, 3-bis-[(2′-cyano-3′, 3′-diphenylacryloyl)oxy]-2, 2-bis[(2-cyano-3, 3-diphenylacryloyl)oxy]methyl) propane and 1, 3-bis-[(2-cyano-3, 3-diphenylacryloyl)oxy]benzene.

A blending amount of the ultraviolet absorber is preferably 0.01 to 3.0 parts by weight with respect to 100 parts by weight of the polycarbonate resin, and when the blending amount is within such a range, it is possible to impart sufficient weather resistance to a molded body of the polycarbonate resin according to the application.

### <Optical Member>

The optical member according to the invention contains the polycarbonate resin. Such an optical member is not particularly limited as long as the polycarbonate resin is useful for optical applications, and examples thereof include an optical disk, a transparent conductive substrate, an optical card, a sheet, a film, an optical fiber, a lens, a prism, an optical film, a substrate, an optical filter, and a hard coat film.

The optical member according to the invention may be formed of a resin composition containing the polycarbonate resin, and the resin composition may contain additives such as a heat stabilizer, a plasticizer, a light stabilizer, a polymerized metal deactivator, a flame retardant, a lubricant, an antistatic agent, a surfactant, an antibacterial agent, an ultraviolet absorber, a release agent, a bluing agent, a filler, and an antioxidant, as necessary.

### <Optical Lens>

Examples of the optical member of the invention particularly include an optical lens. Examples of such an optical lens include imaging lenses for mobile phones, smartphones, tablet terminals, personal computers, digital cameras, video cameras, in-vehicle cameras, surveillance cameras, and the like, and sensing camera lenses for TOF cameras and the like.

When the optical lens according to the invention is manufactured by injection molding, it is preferably molded under conditions of a cylinder temperature of 220° C. to 350° C. and a mold temperature of 70° C. to 180° C. More preferably, molding is performed under conditions of a cylinder temperature of 240° C. to 300° C. and a mold temperature of 80° C. to 170° C. When a cylinder temperature is higher than 350° C., the polycarbonate resin is decomposed and colored, and when the cylinder temperature is lower than 230° C., the melt viscosity is high and molding tends to be difficult. When the mold temperature is higher than 180° C., it tends to be difficult to remove a molded piece made of the polycarbonate resin from the mold. On the other hand, when the mold temperature is lower than 70° C., the resin is solidified too quickly in the mold during molding, and thus it is difficult to control a shape of the molded piece, and it is difficult to sufficiently transfer the shaping mold applied to the mold.

The optical lens according to the invention is preferably in the form of an aspherical lens as necessary. Since the aspherical lens can make spherical aberration substantially zero with one lens, it is not necessary to remove the spherical aberration by a combination of a plurality of spherical lenses, and weight reduction and molding cost reduction can be achieved. Therefore, the aspherical lens is particularly useful as a camera lens among optical lenses.

In addition, since the polycarbonate resin according to the invention has high molding fluidity, it is useful as a material for an optical lens which is thin and small and has a complicated shape, and is particularly useful for an imaging lens and a sensing camera lens. As a specific lens size, a thickness of a central portion is 0.05 mm to 3.0 mm, more preferably 0.05 mm to 2.0 mm, still more preferably 0.1 mm to 2.0 mm, and particularly preferably 0.1 mm to 1.0 mm. A diameter is 1.0 mm to 20.0 mm, more preferably 1.0 mm to 10.0 mm, and still more preferably 3.0 mm to 10.0 mm. It is preferable that the lens be a meniscus lens having one convex surface and one concave surface.

The lens made of the polycarbonate resin according to the invention is molded by any method such as die molding, cutting, polishing, laser processing, electric discharge processing, or etching. Among these, the die molding is more preferable in terms of manufacturing cost.

### Embodiment 2

In the polycarbonate resin according to the invention, matters described in Embodiment 1 can also be applied to Embodiment 2 unless otherwise specified.

### <Polycarbonate Resin>

The polycarbonate resin according to the invention contains a unit represented by Formula (1) and/or Formula (2) and a unit represented by Formula (3), and preferably contains a unit represented by Formula (1) and/or Formula (2) in an amount of 50 mol % or more in all repeating units. The unit represented by Formula (1) and/or Formula (2) is preferably contained in an amount of 90 mol % or less, more preferably 80 mol % or less, and still more preferably 65 mol % or less, in all repeating units. In addition, the unit represented by Formula (3) is preferably contained in an amount of more than 0% and 50 mol % or less in all repeating units. The unit represented by Formula is more preferably contained in an amount of 10 mol % or more, still more preferably 20 mol % or more, and particularly preferably 35 mol % or more, in all repeating units. The above range is preferable because the Abbe number is high and an orientation birefringence and a photoelastic coefficient are excellent. A molar ratio of the unit represented by Formula (1) and/or Formula (2) to the unit represented by Formula (3) is preferably 99:1 to 50:50, more preferably 95:5 to 50:50, even more preferably 90:10 to 50:50, still more preferably 85:15 to 50:50, particularly preferably 80:20 to 50:50, and most preferably 65:35 to 50:50. When the unit represented by Formula (1) and/or Formula (2) and the unit represented by Formula (3) are within the above ranges, the Abbe number is high, and the orientation birefringence and the photoelastic coefficient are excellent, which is preferable.

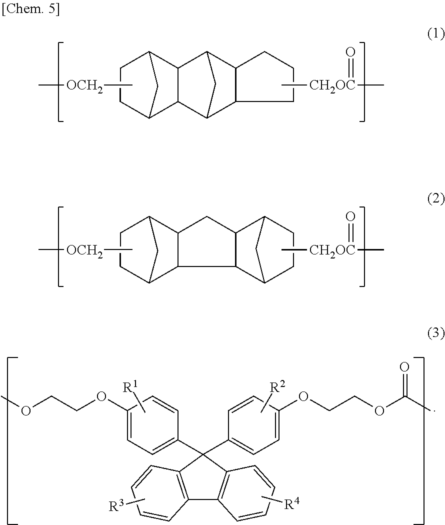

(In the formula, R¹ to R⁴ each independently represent a hydrogen atom or a hydrocarbon group having 1 to 10 carbon atoms.)

The polycarbonate resin according to the invention has a weight average molecular weight Mw of 10,000 or more, preferably 15,000 or more, and more preferably 20,000 or more. When the weight average molecular weight Mw is 10,000 or more, sufficient mechanical strength is obtained as a structural material or an optical material, which is preferable. The weight average molecular weight Mw is 55,000 or less, preferably 50,000 or less, more preferably 40,000 or less, particularly preferably less than 35,000, and most preferably 30,000 or less. When the weight average molecular weight Mw is 50,000 or less, fluidity during injection molding is excellent, which is preferable. In particular, when the polycarbonate resin according to the invention is used for a thin optical member such as an imaging lens, the polycarbonate resin has excellent fluidity, which is preferable. The weight average molecular weight Mw can be measured by GPC using polystyrene having a known molecular weight as a standard sample and chloroform as a developing solvent.

In the polycarbonate resin according to the invention, an absolute value of the orientation birefringence is preferably 7.0×10⁻³ or less, more preferably 5.0×10⁻³ or less, even more preferably 3.0×10⁻³ or less, still more preferably 2.5×10⁻³ or less, particularly preferably 2.0×10⁻³ or less, and most preferably 1.5×10⁻³ or less. When the absolute value of the orientation birefringence is equal to or less than the above, birefringence due to molecular orientation is less likely to occur, which is preferable. The orientation birefringence is measured at a wavelength of 589 nm after a test piece having a length of 70 mm (between chucks of 45 mm) and a width of 15 mm is cut out from a cast film having a thickness of 100 μm obtained from a polycarbonate resin and stretched twice at Tg+10° C.

The polycarbonate resin according to the invention preferably has a photoelastic coefficient of less than 25×10⁻¹² Pa, and more preferably 20×10⁻¹² Pa or less. When the photoelastic coefficient is within the above range, birefringence due to stress is less likely to occur, which is preferable. The photoelastic coefficient is measured by cutting a test piece having a length of 50 mm and a width of 10 mm from a cast film having a thickness of 100 μm obtained from polycarbonate resin, using Spectroellipsometer M-220 manufactured by JASCO Corporation.

In the polycarbonate resin according to the invention, the refractive index nd measured at a temperature of 20° C. and a wavelength of 587.56 nm is preferably 1.540 or more, more preferably 1.550 or more, even more preferably 1.560 or more, still more preferably 1.570 or more, and particularly preferably 1.575 or more. When the refractive index is the above range or more, the optical member can be thinned, which is preferable. The refractive index nd may be 1.610 or less, 1.600 or less, 1.590 or less, or 1.580 or less. When the refractive index nd is within the above range, the degree of freedom in optical design is increased when a plurality of lenses are used in combination, which is preferable.

The polycarbonate resin according to the invention preferably has an Abbe number of 25.0 or more, more preferably 28.0 or more, even more preferably 31.0 or more, still more preferably 34.0 or more, particularly preferably 36.0 or more. When the Abbe number is equal to or greater than the above range, the chromatic aberration of the optical member is reduced, which is preferable. The Abbe number may be 57.0 or less, 55.0 or less, 50.0 or less, or 45.0 or less. When the Abbe number is within the above range, the degree of freedom in optical design is increased when a plurality of lenses are used in combination, which is preferable.

Here, the Abbe number (vd) is calculated using the following formula based on the refractive index at a temperature of 20° C. and wavelengths of 486.13 nm, 587.56 nm, and 656.27 nm.

$$ν d = ( nd - 1 ) / ( nF - nC )$$

nd means a refractive index at a wavelength of 587.56 nm, nF means a refractive index at a wavelength of 486.13 nm, and nC means a refractive index at a wavelength of 656.27 nm.

The polycarbonate resin according to the invention preferably has a glass transition temperature of 130° C. or higher, more preferably 133° C. or higher, and even more preferably 136° C. or higher. When the glass transition temperature is in the above range, a temperature range in which the optical member can be used is increased, which is preferable. The glass transition temperature may be 155° C. or lower, 150° C. or lower, 145° C. or lower, or 140° C. or lower. When the glass transition temperature is within the above range, the balance between heat resistance and moldability is excellent, which is preferable.

The polycarbonate resin according to the invention preferably has a thermal decomposition temperature of 370° C. or higher, more preferably 375° C. or higher. When the thermal decomposition temperature is equal to or higher than the above range, the polycarbonate resin according to the invention is excellent in processing stability at the time of molding, and is also less colored, which is preferable. The thermal decomposition temperature may be 420° C. or lower, or may be 400° C. or lower. The thermal decomposition temperature can be measured by thermogravimetric analysis (TGA), and is a temperature at which the weight is reduced by 5%.

The melt viscosity (Pas) of the polycarbonate resin according to the invention at 260° C. and a shear rate of 1, 216/see is preferably 30 or more, more preferably 50 or more, and still more preferably 70 or more. The melt viscosity (Pas) at 260° C. and a shear rate of 1,216/see is preferably 500 or less, more preferably 400 or less, still more preferably 300 or less, and particularly preferably 200 or less. When the melt viscosity is within the above range, moldability during injection molding is excellent, which is preferable. In particular, when a thin molded product such as a lens is injection-molded, the melt viscosity during molding is important, and when the melt viscosity is within the above range, a target lens shape is obtained, which is preferable. The melt viscosity is measured by Capirograph 1D manufactured by Toyo Seiki Co., Ltd. after drying the polycarbonate resin at 120° C. for 4 hours.

The specific viscosity of the polycarbonate resin according to the invention is preferably 0.12 to 0.32, and more preferably 0.18 to 0.30. When the specific viscosity is 0.12 to 0.32, the balance between moldability and strength is excellent.

As a method for measuring the specific viscosity, a specific viscosity (nSP) at 20° C. of a solution obtained by dissolving 0.7 g of a polycarbonate resin in 100 ml of methylene chloride is measured with an Ostwald viscometer, and the specific viscosity is calculated based on the following formula.

$$η SP = ( t - t 0 ) / t 0$$

[to is the number of seconds that methylene chloride falls, and t is the number of seconds that a sample solution falls]

### Embodiment 3

In the polycarbonate resin according to the invention, the matters described in Embodiment 1 can also be applied to Embodiment 3 unless otherwise specified below.

### <Polycarbonate Resin>

The polycarbonate resin according to the invention contains a unit represented by Formula (1) and/or Formula (2) and a unit represented by Formula (3), and preferably contains a unit represented by Formula (1) and/or Formula (2) in an amount of more than 0 mol % and less than 50 mol % in all repeating units. The unit represented by Formula (1) and/or Formula (2) is preferably contained in an amount of 10 mol % or more, more preferably 20 mol % or more, and still more preferably 35 mol % or more and less than 50 mol % in all repeating units. In addition, the unit represented by Formula (3) is preferably contained in an amount of more than 50 mol % in all repeating units. The unit represented by Formula (3) is preferably contained in an amount of 90 mol % or less, more preferably 80 mol % or less, and still more preferably 65 mol % or less, in all repeating units. The above range is preferable because the orientation birefringence is small, and the refractive index and the glass transition temperature are high. A molar ratio of the unit represented by Formula (1) and/or Formula (2) to the unit represented by Formula (3) is preferably 1:99 to 49:51, more preferably 5:95 to 49:51, even more preferably 10:90 to 49:51, still more preferably 15:85 to 49:51, particularly preferably 20:80 to 49:51, and most preferably 35:65 to 49:51. When the unit represented by Formula (1) and/or Formula (2) and the unit represented by Formula (3) are within the above ranges, the orientation birefringence is small, and the refractive index and the glass transition temperature are high, which is preferable.

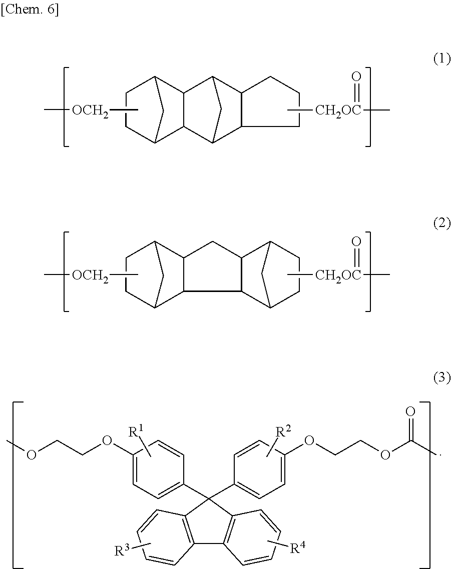

(In the formula, R¹ to R⁴ each independently represent a hydrogen atom or a hydrocarbon group having 1 to 10 carbon atoms.)

The polycarbonate resin according to the invention has a weight average molecular weight Mw of 10,000 or more, preferably 15,000 or more, and more preferably 20,000 or more. When the weight average molecular weight Mw is 10,000 or more, sufficient mechanical strength is obtained as a structural material or an optical material, which is preferable. The weight average molecular weight Mw is 55,000 or less, preferably 50,000 or less, more preferably 40,000 or less, particularly preferably less than 35,000, and most preferably 30,000 or less. When the weight average molecular weight Mw is 50,000 or less, fluidity during injection molding is excellent, which is preferable. In particular, when the polycarbonate resin according to the invention is used for a thin optical member such as an imaging lens, the polycarbonate resin has excellent fluidity, which is preferable. The weight average molecular weight Mw can be measured by GPC using polystyrene having a known molecular weight as a standard sample and chloroform as a developing solvent.

In the polycarbonate resin according to the invention, the absolute value of the orientation birefringence is preferably 3.0×10⁻³ or less, more preferably 2.0×10⁻³ or less, even more preferably 1.0×10⁻³ or less, and still more preferably 0.5×10⁻³ or less. When the absolute value of the orientation birefringence is equal to or less than the above, birefringence due to molecular orientation is less likely to occur, which is preferable. The orientation birefringence is measured at a wavelength of 589 nm after a test piece having a length of 70 mm (between chucks of 45 mm) and a width of 15 mm is cut out from a cast film having a thickness of 100 μm obtained from a polycarbonate resin and stretched twice at Tg+10° C.

The polycarbonate resin according to the invention preferably has a photoelastic coefficient of less than 35×10⁻¹² Pa, more preferably 30×10⁻¹² Pa or less, and still more preferably 25×10⁻¹² Pa or less. When the photoelastic coefficient is within the above range, birefringence due to stress is less likely to occur, which is preferable. The photoelastic coefficient is measured by cutting a test piece having a length of 50 mm and a width of 10 mm from a cast film having a thickness of 100 μm obtained from a polycarbonate resin, using Spectroellipsometer M-220 manufactured by JASCO Corporation.

In the polycarbonate resin according to the invention, the refractive index nd measured at a temperature of 20° C. and a wavelength of 587.56 nm is preferably 1.600 or more, more preferably 1.605 or more, even more preferably 1.610 or more, still more preferably 1.615 or more, and particularly preferably 1.620 or more. When the refractive index is the above range or more, the optical member can be thinned, which is preferable. The refractive index nd may be 1.650 or less, 1.645 or less, 1.640 or less, or 1.635 or less. When the refractive index nd is within the above range, a degree of freedom in optical design is increased when a plurality of lenses are used in combination, which is preferable.

The polycarbonate resin according to the invention preferably has an Abbe number of 25.0 or more, more preferably 30.0 or more. When the Abbe number is equal to or greater than the above range, the chromatic aberration of the optical member is reduced, which is preferable. The Abbe number may be 33.0 or less, or may be 32.0 or less. When the Abbe number is within the above range, the degree of freedom in optical design is increased when a plurality of lenses are used in combination, which is preferable.

Here, the Abbe number (vd) is calculated using the following formula based on the refractive index at a temperature of 20° C. and wavelengths of 486.13 nm, 587.56 nm, and 656.27 nm.

$$ν d = ( nd - 1 ) / ( nF - nC )$$

nd means a refractive index at a wavelength of 587.56 nm, nF means a refractive index at a wavelength of 486.13 nm, and nC means a refractive index at a wavelength of 656.27 nm.

The glass transition temperature of the polycarbonate resin according to the invention is preferably 138° C. or higher, more preferably 140° C. or higher, even more preferably 142° C. or higher, and still more preferably 144° C. or higher. When the glass transition temperature is in the above range, a temperature range in which the optical member can be used is increased, which is preferable. The glass transition temperature may be 160° C. or lower, 155° C. or lower, or 150° C. or lower. When the glass transition temperature is within the above range, the balance between heat resistance and moldability is excellent, which is preferable.

The thermal decomposition temperature of the polycarbonate resin according to the invention is preferably 370° C. or higher, more preferably 375° C. or higher, and still more preferably 380° C. or higher. When the thermal decomposition temperature is equal to or higher than the above range, the polycarbonate resin according to the invention is excellent in processing stability at the time of molding, and is also less colored, which is preferable. The thermal decomposition temperature may be 420° C. or lower, or may be 400° C. or lower. The thermal decomposition temperature can be measured by thermogravimetric analysis (TGA), and is a temperature at which the weight is reduced by 5%.

The melt viscosity (Pas) of the polycarbonate resin according to the invention at 260° C. and a shear rate of 1, 216/see is preferably 30 or more, more preferably 50 or more, and still more preferably 70 or more. The melt viscosity (Pas) at 260° C. and a shear rate of 1,216/see is preferably 500 or less, more preferably 400 or less, still more preferably 300 or less, and particularly preferably 200 or less. When the melt viscosity is within the above range, moldability during injection molding is excellent, which is preferable. In particular, when a thin molded product such as a lens is injection-molded, the melt viscosity during molding is important, and when the melt viscosity is within the above range, a target lens shape is obtained, which is preferable. The melt viscosity is measured by Capirograph 1D manufactured by Toyo Seiki Co., Ltd. after drying the polycarbonate resin at 120° C. for 4 hours.

The specific viscosity of the polycarbonate resin according to the invention is preferably 0.12 to 0.32, and more preferably 0.18 to 0.30. When the specific viscosity is 0.12 to 0.32, the balance between moldability and strength is excellent.

As a method for measuring the specific viscosity, a specific viscosity (nSP) at 20° C. of a solution obtained by dissolving 0.7 g of a polycarbonate resin in 100 ml of methylene chloride is measured with an Ostwald viscometer, and the specific viscosity is calculated based on the following formula.

$$η SP = ( t - t 0 ) / t 0$$

[to is the number of seconds that methylene chloride falls, and t is the number of seconds that a sample solution falls]

The invention will be described more specifically in the following Examples, and the invention is not limited thereto.

### EXAMPLES

The evaluation was performed by the following method.

### <Copolymerization Ratio of Polycarbonate Resin>

A copolymerization ratio of each of polycarbonate resins was calculated by measuring 1H NMR with JNM-ECZ400S manufactured by JEOL.

### <Weight Average Molecular Weight (Mw)>

A weight average molecular weight Mw was measured by EcoSEC HLC-8320GPC manufactured by Tosoh Corporation under the following conditions.

Detector: UV-8420, solvent: chloroform, column: TSKgel SupermultiporeHZM-M×3+TSKgel guardcolumn (4.6×200 nm manufactured by Tosoh Corporation, measurement temperature: 40° C., flow rate: 0.35 ml/min, injection amount: 5 μl, sample concentration: 1 mg/5 ml, standard sample: TSKstandard polystyrene

### <Refractive Index>

After a test piece having a thickness of 3 mm of each polycarbonate resin was prepared and polished, the refractive index nd (587.56 nm) was measured using Calnew precision refractometer KPR-2000 manufactured by Shimadzu Corporation.

### <Abbe Number>

The Abbe number (vd) was calculated using the following formula based on the refractive index at a temperature of 20° C. and wavelengths of 486.13 nm, 587.56 nm, and 656.27 nm.

$$ν d = ( nd - 1 ) / ( nF - nC )$$

nd means a refractive index at a wavelength of 587.56 nm, nF means a refractive index at a wavelength of 486.13 nm, and nC means a refractive index at a wavelength of 656.27 nm.

<Absolute Value (|Δn|) of Orientation Birefringence>

A polycarbonate resin was dissolved in methylene chloride, cast on a glass petri dish, and sufficiently dried to prepare a cast film having a thickness of 100 μm. A test piece having a length of 70 mm (45 mm between chucks) and a width of 15 mm was cut out from the film, stretched twice at Tg+10° C., a retardation (Re) at 589 nm was measured using an ellipsometer M-220 manufactured by JASCO Corporation, and the absolute value f orientation birefringence (|Δn|) was determined from the following formula.

$$\vert Δ n \vert = \vert Re / d \vert$$

Δn: orientation birefringence
Re: retardation (nm)
d: thickness (nm)

### <Photoelastic Coefficient>

A polycarbonate resin was dissolved in methylene chloride, cast on a glass petri dish, and sufficiently dried to prepare a cast film having a thickness of 100 μm. A test piece having a length of 50 mm and a width of 10 mm was cut out from the film, and the photoelastic coefficient was measured using an ellipsometer M-220 manufactured by JASCO Corporation.

### <Glass Transition Temperature (Tg)>

The obtained polycarbonate resin was measured using Discovery DSC 25Auto model manufactured by TA Instruments Japan, Inc., at a rate of temperature increase of 20° C./min.

The sample was measured at 5 mg to 10 mg.

### <Thermal Decomposition Temperature (Td-5)>

The obtained polycarbonate resin was measured at a rate of temperature increase of 20° C./min using SDT650 manufactured by I TA Instruments Japan, Inc., and a temperature at which a weight decreased by 5% based on the weight at 50° C. was determined. The sample was measured at 3 mg to 4 mg.

### <Melt Viscosity (Pas)>

The polycarbonate resin was dried at 120° C. for 4 hours, and then a melt viscosity was measured at 260° C. and a shear rate of 1,216/see using Capillograph 1D manufactured by Toyo Seiki Kogyo Co., Ltd.

### Example 1

87.70 g (0.20 mol) of 9, 9-bis[4-(2-hydroxyethoxy)phenyl]fluorene (hereinafter sometimes abbreviated as BPEF), 52.48 g (0.20 mol) of pentacyclopentadecanedimethanol (hereinafter, sometimes abbreviated as PCPDM), 89.12 (0.42 mol) of diphenyl carbonate, and 17 μL of a 60 mmol/L aqueous sodium bicarbonate solution (2.5 μmol of sodium bicarbonate) and 227 μL of a 274 mmol/L aqueous tetramethylammonium hydroxide solution (15 μmol of tetramethylammonium hydroxide) as catalysts were heated to 180° C. in a nitrogen atmosphere and melted. Thereafter, the temperature was increased to 250° C. at a rate of 60° C./hr while reducing the internal pressure of the reactor to 20 kPa over 40 minutes. After 70% of a theoretical amount of phenol was distilled off, the internal pressure of the reactor was reduced to 133 Pa or less over 1 hour. Thereafter, a mixture was stirred at an internal pressure of the reactor of 133 Pa or less at 260° C. for 40 minutes to terminate the reaction, and the resin was taken out. The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, the obtained resin was dried at 120° C. for 4 hours, and then 0.05% by mass of bis(2,6-di-tert-butyl-4-methylphenyl) pentaerythritol diphosphite and 0.10% by mass of glycerin monostearate were added based on the mass of the resin, followed by pelletization using a vented φ15 mm twin-screw extruder. The pellet was dried at 120° C. for 4 hours, and a lens having a thickness of 0.3 mm, a convex surface curvature radius of 5 mm, a concave surface curvature radius of 4 mm, and a diameter of 5 mm was obtained by injection molding at a cylinder temperature of 260° C. and a mold temperature of Tg −5° C. of the polycarbonate resin.

### Example 2

A polycarbonate resin was produced in the same manner as in Example 1 except that the amount of BPEF charged was 52.62 g (0.12 mol) and the amount of PCPDM charged was 73.47 g (0.28 mol). The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, a lens having a thickness of 0.3 mm, a convex surface curvature radius of 5 mm, a concave surface curvature radius of 4 mm, and a diameter of 5 mm was obtained by injection molding in the same manner as in Example 1.

### Example 3

A polycarbonate resin was produced in the same manner as in Example 1 except that the amount of BPEF charged was 43.85 g (0.10 mol) and the amount of PCPDM charged was 78.72 g (0.30 mol). The copolymerization ratio derived from the BPEF and the PCPDM of the obtained polycarbonate resin was measured by 1H NMR. The weight average molecular weight Mw, the refractive index, the Abbe number, the glass transition thermal decomposition temperature, the temperature, the absolute value of the orientation birefringence, the photoelastic coefficient, and the melt viscosity of the polycarbonate resin were evaluated. Thereafter, a lens having a thickness of 0.3 mm, a convex surface curvature radius of 5 mm, a concave surface curvature radius of 4 mm, and a diameter of 5 mm was obtained by injection molding in the same manner as in Example 1.

### Example 4

A polycarbonate resin was produced in the same manner as in Example 1 except that the amount of BPEF charged was 8.78 g (0.02 mol) and the amount of PCPDM charged was 99.71 g (0.38 mol). The copolymerization ratio derived from the BPEF and the PCPDM of the obtained polycarbonate resin was measured by 1H NMR. The weight average molecular weight MW, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, a lens having a thickness of 0.3 mm, a convex surface curvature radius of 5 mm, a concave surface curvature radius of 4 mm, and a diameter of 5 mm was obtained by injection molding in the same manner as in Example 1.

### Comparative Example 1

45.66 g (0.20 mol) of bisphenol A (hereinafter, sometimes abbreviated as BPA), 52.48 g (0.20 mol) of PCPDM, 86.97 g (0.406 mol) of diphenyl carbonate, and 1.09 mg (12 μmol) of sodium bicarbonate as a catalyst were heated to 180° C. in a nitrogen atmosphere and melted. Thereafter, the internal pressure of the reactor was set to 20 kPa and (150 mmHg, and at the same time, the temperature was increased to 200° C. at a rate of 60° C./hr, and the reaction was performed by keeping the temperature for 40 minutes. Then, the temperature was increased to 225° C. at a rate of 75° C./hr, and 40 minutes after the end of the temperature increase, the internal pressure of the reactor was reduced to 133 Pa (1 mmHg) or less over 1 hour while maintaining the temperature. Thereafter, the temperature was increased to 235° C. at a rate of 105° C./hr, the reaction was performed under stirring for 6 hours in total, nitrogen was blown into the reactor after completion of the reaction, the pressure was returned to a normal pressure, and the obtained resin was taken out. A copolymerization ratio between BPA and PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 2

A polycarbonate resin was produced in the same manner as in Comparative Example 1 except that the amount of BPA charged was 63.92 g (0.28 mol) and the amount of PCPDM charged was 31.49 g (0.12 mol). A copolymerization ratio between BPA and PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated.

Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 3

A polycarbonate resin was produced in the same manner as in Comparative Example 1 except that the amount of BPA charged was 27.40 g (0.12 mol) and the amount of PCPDM charged was 73.47 g (0.28 mol). A copolymerization ratio between BPA and PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 4

87.70 g (0.20 mol) of BPEF, 52.48 g (0.20 mol) of PCPDM, 87.40 g (0.41 mol) of diphenyl carbonate, and 17 μL of a 60 mmol/L aqueous sodium bicarbonate solution (2.5 μmol of sodium bicarbonate) and 227 μL of a 274 mmol/L aqueous tetramethylammonium hydroxide solution (15 μmol of tetramethylammonium hydroxide) as catalysts were heated to 180° C. in a nitrogen atmosphere and melted. Thereafter, the temperature was increased to 250° C. at a rate of 60° C./hr while reducing the internal pressure of the reactor to 20 kPa over 40 minutes. After 70% of a theoretical amount of phenol was distilled off, the internal pressure of the reactor was reduced to 133 Pa or less over 1 hour. Thereafter, a mixture was stirred at an internal pressure of the reactor of 133 Pa or less at 260° C. for 40 minutes to terminate the reaction, and the resin was taken out. The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 5

A polycarbonate resin was produced in the same manner as in Comparative Example 4 except that the amount of BPEF charged was 70.16 g (0.16 mol) and the amount of PCPDM charged was 62.97 g (0.24 mol). The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 6

A polycarbonate resin was produced in the same manner as in Comparative Example 4 except that the amount of BPEF charged was 52.62 g (0.12 mol) and the amount of PCPDM charged was 73.47 g (0.28 mol). The copolymerization ratio derived from the BREF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

TABLE 1

| | | | | | | | | | | Photoelastic | Melt |
|---|---|---|---|---|---|---|---|---|---|---|---|
| | PCPDM | BPEF | BPA | | | | Tg | Td-5 | \|Δn\| | coefficient | viscosity |
| Example | (mol %) | (mol %) | (mol %) | Mw | nd | vd | (° C.) | (° C.) | (×10⁻³) | (10⁻¹² Pa) | (Pa · s) |
| 1 | 50 | 50 | 0 | 31000 | 1.600 | 32 | 141 | 378 | 0.5 | 24 | 155 |
| 2 | 70 | 30 | 0 | 29000 | 1.579 | 36 | 137 | 376 | 1.2 | 18 | 145 |
| 3 | 75 | 25 | 0 | 37900 | 1.573 | 37 | 136 | 375 | 1.4 | 17 | 150 |
| 4 | 95 | 5 | 0 | 37900 | 1.547 | 51 | 130 | 373 | 2.4 | 10 | 140 |
| Comparative | 50 | 0 | 50 | 66300 | 1.562 | 39 | 133 | 377 | 12.2 | 35 | 780 |
| Example 1 | | | | | | | | | | | |
| Comparative | 30 | 0 | 70 | 64000 | 1.573 | 35 | 139 | 380 | 17.1 | 53 | 850 |
| Example 2 | | | | | | | | | | | |
| Comparative | 70 | 0 | 30 | 65000 | 1.550 | 41 | 134 | 373 | 7.5 | 25 | 700 |
| Example 3 | | | | | | | | | | | |
| Comparative | 50 | 50 | 0 | 62000 | 1.600 | 32 | 144 | 378 | 2.5 | 24 | 880 |
| Example 4 | | | | | | | | | | | |
| Comparative | 60 | 40 | 0 | 71000 | 1.590 | 33 | 142 | 377 | 3.3 | 21 | 850 |
| Example 5 | | | | | | | | | | | |
| Comparative | 70 | 30 | 0 | 56800 | 1.579 | 36 | 140 | 376 | 4.3 | 18 | 790 |
| Example 6 | | | | | | | | | | | |

Examples 1 to 4 according to the invention have a lower melt viscosity than that in Comparative Example, and thus have excellent moldability during injection molding. In addition, the since orientation birefringence is excellent, a birefringence due to molecular orientation is less likely to occur when an optical member is obtained by injection molding or the like. In addition, since the photoelastic coefficient is small, a birefringence due to stress is less likely to occur when an optical member is obtained by injection molding or the like. Therefore, the birefringence of the optical member is reduced, which is preferable.

### Example 5

166.64 g (0.38 mol) of 9,9-bis[4-(2-hydroxyethoxy)phenyl]fluorene (hereinafter sometimes (0.02 mol) of abbreviated as BPEF), 5.25 g pentacyclopentadecanedimethanol (hereinafter, sometimes abbreviated as PCPDM), 89.12 g (0.42 mol) of diphenyl carbonate, and 17 μL of a 60 mmol/L aqueous sodium bicarbonate solution (2.5 μmol of sodium bicarbonate) and 227 μL of a 274 mmol/L aqueous tetramethylammonium hydroxide solution (15 μmol of tetramethylammonium hydroxide) as catalysts were heated to 180° C. in a nitrogen atmosphere and melted. Thereafter, the temperature was increased to 250° C. at a rate of 60° C./hr while reducing the internal pressure of the reactor to 20 kPa over 40 minutes. After 70% of a theoretical amount of phenol was distilled off, the internal pressure of the reactor was reduced to 133 Pa or less over 1 hour. Thereafter, a mixture was stirred at an internal pressure of the reactor of 133 Pa or less at 260° C. for 40 minutes to terminate the reaction, and the resin was taken out. The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, a lens having a thickness of 0.3 mm, a convex surface curvature radius of 5 mm, a concave surface curvature radius of 4 mm, and a diameter of 5 mm was obtained by injection molding in the same manner as in Example 1.

### Example 6

A polycarbonate resin was produced in the same manner as in Example 1 except that the amount of BPEF charged was 131.56 g (0.30 mol) and the amount of PCPDM charged was 26.24 g (0.10 mol). The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, a lens having a thickness of 0.3 mm, a convex surface curvature radius of 5 mm, a concave surface curvature radius of 4 mm, and a diameter of 5 mm was obtained by injection molding in the same manner as in Example 1.

### Example 7

A polycarbonate resin was produced in the same manner as in Example 1 except that the amount of BPEF charged was 96.47 g (0.22 mol) and the amount of PCPDM charged was 47.23 g (0.18 mol). The copolymerization ratio derived from the BPEF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, a lens having a thickness of 0.3 mm, a convex surface curvature radius of 5 mm, a concave surface curvature radius of 4 mm, and a diameter of 5 mm was obtained by injection molding in the same manner as in Example 1.

### Comparative Example 7

45.66 g (0.20 mol) of bisphenol A (hereinafter, sometimes abbreviated as BPA), 52.48 g (0.20 mol) of PCPDM, 86.97 g (0.406 mol) of diphenyl carbonate, and 1.09 mg (12 μmol) of sodium bicarbonate as a catalyst were heated to 180° C. in a nitrogen atmosphere and melted. Thereafter, the internal pressure of the reactor was set to 20 kPa (150 mmHg), and at the same time, the temperature was increased to 200° C. at a rate of 60° C./hr, and the reaction was performed by keeping the temperature for 40 minutes. Then, the temperature was increased to 225° C. at a rate of 75° C./hr, and 40 minutes after the end of the temperature increase, the internal pressure of the reactor was reduced to 133 Pa (1 mmHg) or less over 1 hour while maintaining the temperature. Thereafter, the temperature was increased to 235° C. at a rate of 105° C./hr, the reaction was performed under stirring for 6 hours in total, nitrogen was blown into the reactor after completion of the reaction, the pressure was returned to a normal pressure, and the obtained resin was taken out. A copolymerization ratio between BPA and PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 8

A polycarbonate resin was produced in the same manner as in Comparative Example 1 except that the amount of BPA charged was 63.92 g (0.28 mol) and the amount of PCPDM charged was 31.49 g (0.12 mol). A copolymerization ratio between BPA and PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 9

A polycarbonate resin was produced in the same manner as in Comparative Example 1 except that the amount of BPA charged was 27.40 g (0.12 mol) and the amount of PCPDM charged was 73.47 g (0.28 mol). A copolymerization ratio between BPA and PCPDM of the obtained polycarbonate resin was measured by 1H NMR. The weight average molecular weight MW, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

### Comparative Example 10

A polycarbonate resin was produced in the same manner as in Comparative Example 4 except that the amount of BPEF charged was 122.79 g (0.28 mol) and the amount of PCPDM charged was 31.49 g (0.12 mol). The copolymerization ratio derived from the BREF and the PCPDM of the obtained polycarbonate resin was measured by 1H NMR. The weight average molecular weight Mw, the refractive index, the Abbe number, the glass transition temperature, the thermal decomposition temperature, the absolute value of the orientation birefringence, the photoelastic coefficient, and the melt viscosity of the polycarbonate resin were evaluated. Thereafter, an attempt was made to injection mold a lens having a thickness of 0.3 mm, a convex surface curvature radius of 5 mm, a concave surface curvature radius of 4 mm, and a diameter of 5 mm, using the same method as in Example 1, but due to the high melt viscosity of the resin, it was not possible to mold a thin lens of that shape.

TABLE 2

| | | | | | | | | | | Photoelastic | Melt |
|---|---|---|---|---|---|---|---|---|---|---|---|
| | PCPDM | BPEF | BPA | | | | Tg | Td-5 | \|Δn\| | coefficient | viscosity |
| Example | (mol %) | (mol %) | (mol %) | Mw | nd | vd | (° C.) | (° C.) | (×10⁻³) | (10⁻¹² Pa) | (Pa · s) |
| 5 | 5 | 95 | 0 | 25000 | 1.635 | 25 | 147 | 385 | 0.7 | 32 | 160 |
| 6 | 25 | 75 | 0 | 46600 | 1.621 | 27 | 144 | 382 | 0.0 | 29 | 180 |
| 7 | 45 | 55 | 0 | 29900 | 1.605 | 31 | 141 | 378 | 0.3 | 25 | 150 |
| Comparative | 50 | 0 | 50 | 66300 | 1.562 | 39 | 133 | 377 | 12.2 | 35 | 780 |
| Example 7 | | | | | | | | | | | |
| Comparative | 30 | 0 | 70 | 64000 | 1.573 | 35 | 139 | 380 | 17.1 | 53 | 850 |
| Example 8 | | | | | | | | | | | |
| Comparative | 70 | 0 | 30 | 65000 | 1.550 | 41 | 134 | 373 | 7.5 | 25 | 700 |
| Example 9 | | | | | | | | | | | |
| Comparative | 30 | 70 | 0 | 57000 | 1.617 | 27 | 146 | 382 | 1.0 | 30 | 870 |
| Example 10 | | | | | | | | | | | |

Examples 5 to 7 according to the invention have a lower melt viscosity than that in Comparative Example, and thus have excellent moldability during injection molding. In addition, since the orientation birefringence is excellent, a birefringence due to molecular orientation is less likely to occur when an optical member is obtained by injection molding or the like. In addition, since the refractive index and the glass transition temperature are high, it is preferable as an optical member.

### INDUSTRIAL APPLICABILITY

The polycarbonate resin according to the invention is used for an optical material, and can be used for an optical member such as a lens, a prism, an optical disk, a transparent conductive substrate, an optical card, a sheet, a film, an optical fiber, an optical film, an optical filter, or a hard coat film, and is particularly useful for an imaging lens or a sensing camera lens, and is extremely useful for an imaging lens.

1. A polycarbonate resin comprising: a unit represented by Formula (1) and/or Formula (2); and a unit represented by Formula (3), wherein the polycarbonate resin has a weight average molecular weight Mw of 10,000 to 55,000, 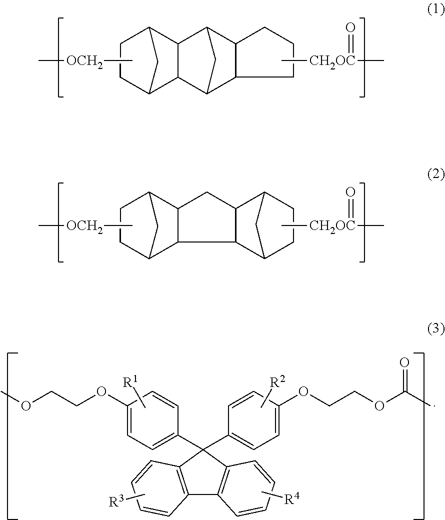
wherein R¹ to R⁴ each independently represent a hydrogen atom or a hydrocarbon group having 1 to 10 carbon atoms.

2. The polycarbonate resin according to claim 1, wherein R¹ to R⁴ in the Formula (3) are each a hydrogen atom.

3. The polycarbonate resin according to claim 1, wherein a molar ratio of the unit represented by Formula (1) and/or Formula (2) to the unit represented by Formula (3) is 99:1 to 1:99.

4. The polycarbonate resin according to claim 3, wherein the molar ratio of the unit represented by Formula (1) and/or Formula (2) to the unit represented by Formula (3) is 65:35 to 35:65.

5. The polycarbonate resin according to claim 1, wherein an absolute value of orientation birefringence is 7.0×10⁻³ or less.

6. The polycarbonate resin according to claim 1, wherein the polycarbonate resin has a photoelastic coefficient of less than 35×10⁻¹² Pa.

7. The polycarbonate resin according to claim 1, wherein the unit represented by Formula (1) and/or Formula (2) is contained in an amount of 50 mol % or more in all repeating units, and the weight average molecular weight Mw is 10,000 to 50,000.

8. The polycarbonate resin according to claim 7, wherein the unit represented by Formula (3) is contained in an amount of more than 0 mol % and 50 mol % or less in all repeating units.

9. The polycarbonate resin according to claim 7, wherein a molar ratio of the unit represented by Formula (1) and/or Formula (2) to the unit represented by Formula (3) is 99:1 to 50:50.

10. The polycarbonate resin according to claim 7, wherein the polycarbonate resin has a photoelastic coefficient of less than 25×10⁻¹² Pa.

11. The polycarbonate resin according to claim 7, wherein the polycarbonate resin has an Abbe number of 25.0 or more.

12. The polycarbonate resin according to claim 1, wherein the unit represented by Formula (1) and/or Formula (2) is contained in an amount of more than 0 mol % and less than 50 mol % in all repeating units, and the weight average molecular weight Mw is 10,000 to 50,000.

13. The polycarbonate resin according to claim 12, wherein the unit represented by Formula (3) is contained in an amount of more than 50 mol % in all repeating units.

14. The polycarbonate resin according to claim 12, wherein a molar ratio of the unit represented by Formula (1) and/or Formula (2) to the unit represented by Formula (3) is 1:99 to 49:51.

15. The polycarbonate resin according to claim 12, wherein an absolute value of orientation birefringence is 3.0×10⁻³ or less.

16. The polycarbonate resin according to claim 12, wherein the polycarbonate resin has a refractive index nd of 1.600 or more.

17. The polycarbonate resin according to claim 12, wherein the polycarbonate resin has a glass transition temperature of 140° C. or higher.

18. An optical member comprising: the polycarbonate resin according to claim 1.

19. The optical member according to claim 18, wherein the optical member is an imaging lens or a sensing camera lens.

20. The imaging lens or the sensing camera lens according to claim 19, wherein a thickness of a central portion is 0.05 mm to 3.0 mm.
